(19) United States
(12) Patent Application Publication
(10) Pub. No.: US 2008/0020186 A1
(43) Pub. Date: Jan. 24, 2008

(54) CALENDERING PROCESS FOR MAKING AN OPTICAL FILM

(75) Inventors: Timothy J. Hebrink, Scandia, MN (US); Matthew B. Johnson, St. Paul, MN (US); Terry O. Collier, Woodbury, MN (US); Carl A. Stover, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/779,701

(22) Filed: Jul. 18, 2007

Related U.S. Application Data
(60) Provisional application No. 60/807,655, filed on Jul. 18, 2006.

(51) Int. Cl. B32B 3/30; B29D 11/00; B32B 33/00; B29D 7/01

(52) U.S. Cl. 428/167; 264/1.31; 264/1.34; 428/220

(57) ABSTRACT

A method of making an optical film includes calendering at least one polymeric material and stretching the at least one polymeric material along a downweb (MD) direction, thereby creating birefringence in the polymeric material. A roll of optical film includes an oriented optical film characterized by an effective orientation axis, the oriented optical film including a birefringent polymeric material, the optical film having a width of greater than 0.3 m, a thickness of at least 200 microns and a length a length of at least 10 m, wherein the effective orientation axis is aligned along the length of the optical film.

### CROSS-REFERENCE TO RELATED APPLICATION

This application claims priority from U.S. Provisional Application No. 60/807,655 filed Jul. 18, 2006 for “Calendering Process for Making an Optical Film,” which is incorporated herein by reference in its entirety.

### TECHNICAL FIELD

This disclosure relates generally to an optical film and methods of processing optical films by calendering.

### BACKGROUND

In commercial processes, optical films made from polymeric materials or blends of materials are typically extruded from a die or cast from solvent. The extruded or cast film is then stretched to create and/or enhance birefringence in at least some of the materials. The materials and the stretching protocol may be selected to produce an optical film such as a reflective optical film, for example, a reflective polarizer or a mirror.

In one commercial process used to make reflective polarizing films, a die is constructed to make an extruded film that is then stretched along the downweb direction in a length orienter (LO), which is an arrangement of rollers rotating at differing speeds selected to stretch the film along the machine direction (MD) and increase its length. The resulting reflective polarizing film can have block axis along the MD. However, when extrusion dies are constructed to make the film in a commercially useful width, the extruded film usually includes striations or die lines along its length, as well as areas of non-uniform width. These defects become more severe after the film is stretched along the MD in the LO, which results in a reflective polarizing film that is generally unacceptable for use in typical optical devices such as displays.

To reduce defects such as die lines and provide an optical film having a substantially uniform width, conventional reflective polarizing films are typically extruded from relatively narrow dies and then stretched in a crossweb direction (referred to herein as the transverse direction or TD). In this conventional reflective polarizing film, the block axis is along the TD.

In one application, these reflective polarizing optical films are laminated to a conventional dichroic polarizing film to make, for example, a film construction for a liquid crystal display (LCD). When supplied in roll form, the dichroic polarizing film has a block axis along the length of the roll (MD), normal to the block axis of the reflective polarizing optical film, which is along the TD. As a result of the differing orientation of the block axes in the dichroic polarizer and the reflective polarizing film, to make the laminate film construction, the reflective polarizer must first be cut into sheets, rotated 90°, and then laminated to the dichroic polarizing film. This laborious process makes it difficult to produce laminated film constructions in roll form on a commercial scale and increases the cost of the final product.

Thus, there is a need for a process for making a defect-free optical film that is oriented in the MD. In one embodiment, the process results in a reflective polarizing film.

### SUMMARY

A method of making an optical film includes calendering at least one polymeric material and stretching the at least one polymeric material along a downweb (MD) direction, thereby creating birefringence in the polymeric material. Another embodiment of a method of making an optical film includes providing a first film and attaching a second film to the first film. In this embodiment, the step of providing the first film includes calendering at least one polymeric material and stretching the at least one polymeric material along a downweb (MD) direction, thereby creating birefringence in the polymeric material. Another method of processing an optical film includes calendering a polymeric material comprising a first polymer and a second polymer, wherein the first polymer develops birefringence and the second polymer is substantially isotropic.

Another exemplary implementation of the present disclosure is an optical film made by the process of calendering at least one polymeric material and stretching the at least one polymeric material along a downweb (MD) direction, thereby creating birefringence in the polymeric material. In yet another exemplary embodiment, a roll of optical film includes an oriented optical film characterized by an effective orientation axis, the oriented optical film including a birefringent polymeric material, the optical film having a width of greater than 0.3 m, a thickness of at least 200 microns and a length a length of at least 10 m, wherein the effective orientation axis is aligned along the length of the optical film.

The above summary is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIGS. 1A and 1B illustrate optical films;

FIG. 2 illustrates a blended optical film;

FIG. 3 is a schematic diagram of one embodiment of a film line of the present disclosure using a calender and length orienter.

FIG. 3A is a schematic diagram of one embodiment of film threading in a length orienter station.

FIG. 3B is a schematic diagram of another embodiment of film threading in a length orienter station.

FIG. 3C is a schematic diagram of a portion of another embodiment of a film line of the present disclosure.

FIG. 3D is a schematic diagram of a portion of yet another embodiment of a film line of the present disclosure.

FIG. 3E is a schematic diagram of a portion of yet another embodiment of a film line of the present disclosure.

FIG. 3F is a schematic isometric view of a roll used in an embodiment of the present disclosure.

FIG. 4 illustrates a laminate construction in which a first optical film is attached to a second optical film;

FIGS. 5A-5B are cross-sectional views of exemplary constructions made according to the present disclosure;

FIGS. 6A-6C are cross-sectional views of exemplary constructions made according to the present disclosure; and

FIG. 7 is a cross-sectional view of an exemplary construction made according to the present disclosure.

### DETAILED DESCRIPTION

The present disclosure is directed to making optical films. Optical films differ from other films, for example, in that they are required to have uniformity and sufficient optical quality designed for a particular end use application, for example, optical displays. For the purposes of this application, sufficient quality for use in optical displays means that the films in roll form, following all processing steps and prior to lamination to other films, are free of visible defects, e.g., have substantially no color streaks or surface ridges running in the MD when viewed by an unaided human eye. In addition, an exemplary embodiment of an optical quality film of the present disclosure has a caliper variation over the useful film area of less than 5% (+/−2.5%), preferably less than 3.5% (+/−1.75%), less than 3% (+/−1.5%), and more preferably less than 1% (+/−0.5%) of the average thickness of the film.

In one traditional commercial process used to make reflective polarizing films, a die was constructed to make an extruded film that was then stretched along the downweb direction in a length orienter (LO), which is an arrangement of rollers rotating at differing speeds selected to stretch the film along the film length direction, which also may be referred to as the machine direction (MD). In such traditional methods, the film length increases while the film width decreases. A film produced using such methods, which may be a reflective polarizing film, has a block axis (i.e., the axis characterized by a low transmission of light polarized along that direction) along the MD. However, it is believed that using traditional LOs to produce oriented optical films results in films of relatively narrow width, such as 0.3 m or less.

To address this problem, wide extrusion dies were constructed to make the film of a commercially useful width. However the extruded film included striations or die lines along its length. These defects typically became more severe after the film was stretched along the MD in the LO, which resulted in an optical film that was unacceptable for use in optical devices such as displays.

To reduce defects, such as die lines, and provide a film having a substantially uniform width, optical films, such as reflective polarizing films, have been extruded from relatively narrow dies and then stretched in a crossweb or film width direction (referred to herein as the transverse direction or TD). Usually, such reflective polarizing films have a block axis along the TD.

In some applications, it is advantageous to laminate a reflective polarizing film to a dichroic polarizing film to make, for example, a film construction for a liquid crystal display (LCD). When supplied in roll form, the dichroic polarizing film usually has a block axis along the length of the roll (MD). The block axis in the dichroic polarizing film and the reflective polarizing film discussed above are perpendicular to one another. To make the laminate film construction for an optical display, the reflective polarizing film must first be cut into sheets, rotated 90°, and then laminated to the dichroic polarizing film. This laborious process makes it difficult to produce laminated film constructions in roll form on a commercial scale and increases the cost of the final product. Thus, there remains a need for wider reflective polarizing films that have a block axis in the MD.

Accordingly, the present disclosure is directed to methods for making wider optical films, such as reflective polarizing films having a polarizing axis along their length (along the MD). The reflective polarizing films may include, without limitation, multilayer reflective polarizing films and diffusely reflective polarizing optical films. In some exemplary embodiments, the reflective polarizing films may be advantageously laminated to other optical films in roll-to-roll processes. In the context of the present disclosure, a reflective polarizer preferentially reflects light of a first polarization and preferentially transmits light of a second, different polarization. Preferably, a reflective polarizer reflects a majority of light of a first polarization and transmits a majority of light of a second, different polarization.

For the purposes of the present application, the term “wide” or “wide format” refers to films having a width of greater than about 0.3 m. Those of ordinary skill in the art will readily appreciate that the term “width” will be used in reference to the useful film width, since some portions of the edge of the film may be rendered unusable or defective, e.g., by the gripping members of a tenter. The wide optical films of the present disclosure have a width that may vary depending on the intended application, but widths typically range from over 0.3 m to 10 m. In some applications, films wider than 10 m may be produced, but such films may be difficult to transport. Exemplary suitable films typically have widths from about 0.5 m to about 2 m and up to about 7 m, and currently available display products utilize films having widths of, for example, 0.65 m, 1.3 m, 1.6 m or 1.8 m. The term “roll” refers to a continuous film having a length of at least 10 m. In some exemplary embodiments of the present disclosure, the length of the film may be 20 m or more, 50 m or more, 100 m or more, 200 m or more or any other suitable length.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

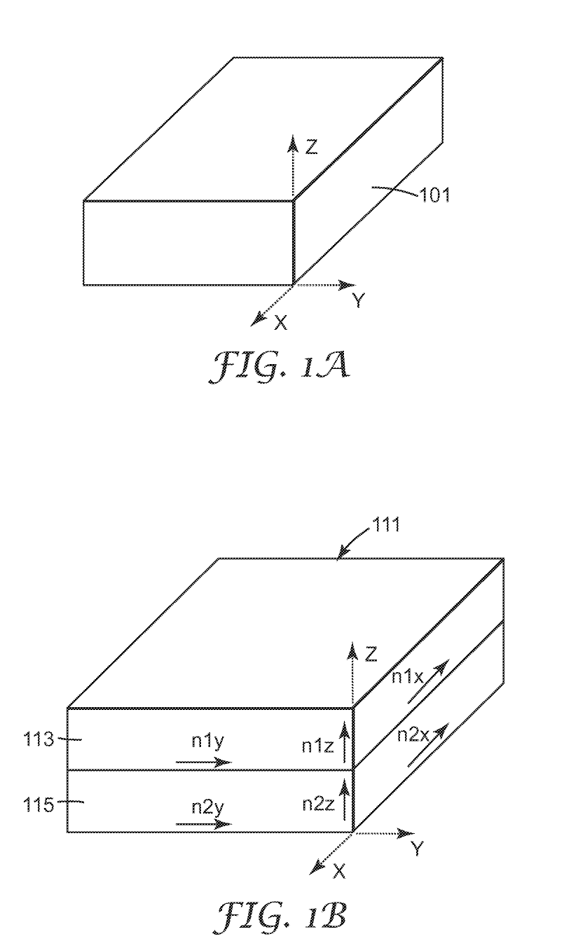

FIG. 1A illustrates a portion of an optical film construction 101 that may be formed in the processes described below. The depicted optical film 101 may be described with reference to three mutually orthogonal axes x, y and z. In the illustrated embodiment, two orthogonal axes x and y are in the plane of the film 101 (in-plane, or x and y axes) and a third axis (z-axis) extends in the direction of the film thickness. In some exemplary embodiments, the optical film 101 includes at least two different materials, a first material and a second material, which are optically interfaced (e.g., two materials combine to cause an optical effect such as reflection, scattering, transmission, etc.). In typical embodiments of the present disclosure, one or both materials are polymeric. The first and second materials may be selected to produce a desired mismatch of refractive indices in a direction along at least one axis of the film 101. The materials may also be selected produce a desired match of refractive indices in a direction along at least one axis of the film 101 perpendicular to a direction along which the refractive indices are mismatched. At least one of the materials is subject to developing birefringence under certain conditions. The materials used in the optical film are preferably selected to have sufficiently similar rheology (e.g., visco-elasticity) to meet the requirements of a coextrusion process, although cast films can also be used. In other exemplary embodiments, the optical film 101 may be composed of only one material or a miscible blend of two or more materials.

The optical film 101 can be a result of a film processing method that may include drawing or stretching the film. Drawing a film under different processing conditions may result in widening of the film without strain-induced orientation, widening of the film with strain-induced orientation, or strain-induced orientation of the film with lengthening. Strain can also be introduced by a compression step, such as by calendering. Generally, the forming process can include either type of orientation (extension or compression-type) or it can include both; one embodiment includes a step imparting both compression and extension simultaneously. The induced molecular orientation may be used, for example, to change the refractive index of an affected material in the direction of the draw. The amount of molecular orientation induced by the draw can be controlled based on the desired properties of the film, as described more fully below.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the difference between the in-plane indices (nₓ and n_{y}) of refraction. The term “out-of-plane birefringence” is understood to be the difference between one of the in-plane indices (nₓ or n_{y}) of refraction and the out-of-plane index of refraction n_{z}. The in-plane directions may also be referred to as the crossweb/transverse direction (TD) and the downweb/machine direction (MD). The out-of-plane direction may also be referred to as the normal direction (ND). All birefringence and index of refraction values are reported for 632.8 nm light unless otherwise indicated.

It will be appreciated that the refractive index in a material is a function of wavelength (i.e., materials typically exhibit dispersion). Therefore, the optical requirements on refractive index are also a function of wavelength. The index ratio of two optically interfaced materials can be used to calculate the reflective power of the two materials. The absolute value of the refractive index difference between the two materials for light polarized along a particular direction divided by the average refractive index of those materials for light polarized along the same direction is descriptive of the film's optical performance. This will be called the normalized refractive index difference.

In a reflective polarizer, it is generally desirable that the normalized difference, if any, in mismatched in-plane refractive indices, e.g., in-plane (MD) direction, be at least about 0.06, more preferably at least about 0.09, and even more preferably at least about 0.11 or more. More generally, it is desirable to have this difference as large as possible without significantly degrading other aspects of the optical film. It is also generally desirable that the normalized difference, if any, in matched in-plane refractive indices, e.g., in the in-plane (TD) direction, be less than about 0.06, more preferably less than about 0.03, and most preferably less than about 0.01. Similarly, it can be desirable that any normalized difference in refractive indices in the thickness direction of a polarizing film, e.g., in the out-of-plane (ND) direction, be less than about 0.11, less than about 0.09, less than about 0.06, more preferably less than about 0.03, and most preferably less than about 0.01. In certain instances it may desirable to have a controlled mismatch in the thickness direction of two adjacent materials in a multilayer stack. The influence of the z-axis refractive indices of two materials in a multilayer film on the optical performance of such a film are described more fully in U.S. Pat. No. 5,882,774, entitled Optical Film; U.S. Pat. No. 6,531,230, entitled “Color Shifting Film;” and U.S. Pat. No. 6,157,490, entitled “Optical Film with Sharpened Bandedge,” the contents of which are incorporated herein by reference.

Exemplary embodiments of the present disclosure also may be characterized by “an effective orientation axis,” which is the in-plane direction in which the refractive index has changed the most as a result of strain-induced orientation. For example, the effective orientation axis typically coincides with the block axis of a polarizing film, reflective or absorbing. In general, there are two principal axes for the in-plane refractive indices, which correspond to maximum and minimum refractive index values. For a positively birefringent material, in which the refractive index tends to increase for light polarized along the main axis or direction of stretching, the effective orientation axis coincides with the axis of maximum in-plane refractive index. For a negatively birefringent material, in which the refractive index tends to decrease for light polarized along the main axis or direction of stretching, the effective orientation axis coincides with the axis of minimum in-plane refractive index.

The optical film 101 is typically formed using two or more different materials. In some exemplary embodiments, the optical film of the present disclosure includes only one birefringent material. In other exemplary embodiments, the optical film of the present disclosure includes at least one birefringent material and at least one isotropic material. In yet other exemplary embodiments, the optical film includes a first birefringent material and a second birefringent material. In such exemplary embodiments, the in-plane refractive indices of both materials change similarly in response to the same process conditions. In one embodiment, when the film is drawn, the refractive indices of the first and second materials should both increase for light polarized along the direction of the draw (e.g., the MD) while decreasing for light polarized along a direction orthogonal to the stretch direction (e.g., the TD). In another embodiment, when the film is drawn, the refractive indices of the first and second materials should both decrease for light polarized along the direction of the draw (e.g., the MD) while increasing for light polarized along a direction orthogonal to the stretch direction (e.g., the TD). In general, where one, two or more birefringent materials are used in an oriented optical film according to the present disclosure, the effective orientation axis of each birefringent material is aligned along the MD.

When the orientation resulting from a combination of calendering and stretching steps causes a match of the refractive indices of the two materials in one in-plane direction and a substantial mismatch of the refractive indices in the other in-plane direction, the film is especially suited for fabricating an optical polarizer. The matched direction forms a transmission (pass) direction for the polarizer and the mismatched direction forms a reflection (block) direction. Generally, the polarization efficiency of the polarizer improves with a larger mismatch in refractive indices in the reflection direction and a closer match in the refractive indices in the transmission direction.

FIG. 1B illustrates a multilayer optical film 111 that includes a first layer of a first material 113 disposed (e.g., by coextrusion) on a second layer of a second material 115. Either or both of the first and second materials may be positively or negatively birefringent. While only two layers are illustrated in FIG. 1B and generally described herein, the process is applicable to multilayer optical films having up to hundreds or thousands or more of layers made from any number of different materials. The multilayer optical film 111 or the optical film 101 may include additional layers. The additional layers may be optical, e.g., performing an additional optical function, or non-optical, e.g., selected for their mechanical or chemical properties. As discussed in U.S. Pat. No. 6,179,948, incorporated herein by reference, these additional layers may be orientable under the process conditions described herein, and may contribute to the overall optical and/or mechanical properties of the film.

In one embodiment, the materials in the optical film 111 are selected to have visco-elasticity characteristics to at least partially decouple the draw behavior of the two materials 113 and 115 in the film 111. For example, in some exemplary embodiments, it is advantageous to decouple the responses of the two materials 113 and 115 to stretching or drawing. By decoupling the draw behavior, changes in the refractive indices of the materials may be separately controlled to obtain various combinations of orientation states, and, consequently, the degrees of birefringence, in the two different materials. In one such process, two different materials form optical layers of a multilayer optical film, such as a coextruded multilayer optical film. The indices of refraction of the layers can have an initial isotropy (i.e., the indices are the same along each axis) although some orientation during the casting process may be purposefully or incidentally introduced in the extruded films.

One approach to forming a reflective polarizer uses a first material that becomes birefringent as a result of processing according to the present disclosure and a second material having an index of refraction which remains substantially isotropic, i.e., does not develop appreciable amounts of birefringence, during the draw process. In some exemplary embodiments, the second material is selected to have a refractive index which matches the non-drawn in-plane refractive index of the first material subsequent to the draw.

Materials suitable for use in the optical films of FIGS. 1A, 1B are discussed in, for example, U.S. Pat. No. 5,882,774, which is incorporated herein by reference. Suitable materials include polymers such as, for example, polyesters, copolyesters and modified copolyesters. In this context, the term “polymer” will be understood to include homopolymers and copolymers, as well as polymers or copolymers that may be formed in a miscible blend, for example, by co-extrusion or by reaction, including, for example, transesterification. The terms “polymer” and “copolymer” include both random and block copolymers. Polyesters suitable for use in some exemplary optical films of the optical bodies constructed according to the present disclosure generally include carboxylate and glycol subunits and can be generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof; terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof, t-butyl isophthalic acid, trimellitic acid, sodium sulfonated isophthalic acid; 4,4′-biphenyl dicarboxylic acid and isomers thereof; and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof; 1,6-hexanediol; neopentyl glycol; polyethylene glycol; diethylene glycol; tricyclodecanediol; 1,4-cyclohexanedimethanol and isomers thereof, norbornanediol; bicyclo-octanediol; trimethylol propane; pentaerythritol; 1,4-benzenedimethanol and isomers thereof, bisphenol A; 1,8-dihydroxy biphenyl and isomers thereof, and 1,3-bis (2-hydroxyethoxy)benzene.

An exemplary polymer useful in the optical films of the present disclosure is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyhexamethylene naphthalate (PHN), polyethylene terephthalate (PET), polybutylene terephthalate (PBT), polyhexamethylene terephthalate (PHT), and copolymers thereof.

In an exemplary embodiment, a second polymer of the second optical layers is chosen so that in the finished film, the refractive index, in at least one direction, differs significantly from the index of refraction of the first polymer in the same direction. Because polymeric materials are typically dispersive, that is, their refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

Other materials suitable for use in optical films and, particularly, as a first polymer of the first optical layers, are described, for example, in U.S. Pat. Nos. 6,352,761, 6,352,762 and 6,498,683 and U.S. patent application Ser. No. 09/229,724 and Ser. No. 09/399,531, which are incorporated herein by reference. Another polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction of that polymer is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second optical layers can be made from a variety of polymers having glass transition temperatures compatible with that of the first polymer and having a refractive index similar to one refractive index plane of the first polymer. Examples of other polymers suitable for use in optical films, and particularly in the second optical layers or minor phases in blended optical films, include vinyl polymers and copolymers made from monomers such as vinyl naphthalenes, styrene, styrene acrylonitrile, maleic anhydride, acrylates, and methacrylates. Examples of such polymers include polyacrylates, polymethacrylates, such as poly (methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers or copolymers of, or blends of copolyesters and polycarbonates such as, SA115 from Eastman, Xylex from GE, or Makroblend from Bayer.

Other exemplary suitable polymers, especially for use in the second optical layers, include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008. Additional copolymers useful as second optical layers or minor phases in blends include styrene acrylate copolymers such as NAS30 from Noveon and MS600 from Sanyo Chemicals.

Yet other suitable polymers, especially for use in the second optical layers, include polyolefin copolymers such as poly (ethylene-co-octene) (PE-PO) available from Dow-Dupont Elastomers under the trade designation Engage 8200, poly (propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. The optical films can also include, for example in the second optical layers, a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Exemplary combinations of materials in the case of polarizers include PEN/co-PEN, polyethylene terephthalate (PET)/co-PEN, PEN/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co. Exemplary combinations of materials in the case of mirrors include PET/coPMMA, PEN/PMMA or PEN/coPMMA, PET/ECDEL, PEN/ECDEL, PEN/sPS, PEN/THV, PEN/co-PET, and PET/coPMMA, where “co-PET” refers to a copolymer or blend based upon terephthalic acid (as described above), ECDEL is a thermoplastic polyester commercially available from Eastman Chemical Co., and THV is a fluoropolymer commercially available from 3M Company. PMMA refers to polymethyl methacrylate and PETG refers to a copolymer of PET employing a second glycol comonomer (cyclohexanedimethanol). sPS refers to syndiotactic polystyrene.

In another embodiment, the optical film can be or can include a reflective polarizer which is a blend optical film. In a typical blend film, a blend (or mixture) of at least two different materials is used. A mismatch in refractive indices of the two or more materials along a particular axis can be used to cause incident light that is polarized along that axis to be substantially scattered, resulting in a significant amount of diffuse reflection of that light. Incident light that is polarized in the direction of an axis in which the refractive indices of the two or more materials are matched will be substantially transmitted or at least transmitted with a much lesser degree of scattering. By controlling the relative refractive indices of the materials, among other properties of the optical film, a diffusely reflective polarizer may be constructed. Such blend films may assume a number of different forms. For example, the blend optical film may include one or more disperse phases within one or more continuous phases, or co-continuous phases. The general formation and optical properties of various blend films are further discussed in U.S. Pat. Nos. 5,825,543 and 6,111,696, the disclosures of which are incorporated by reference herein.

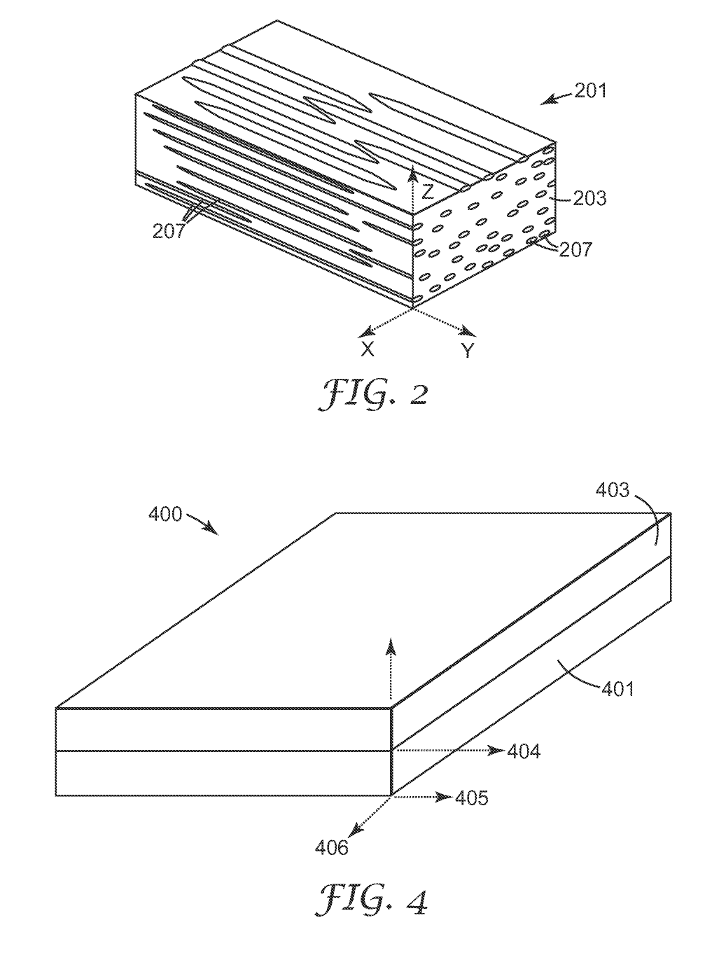

FIG. 2 illustrates an embodiment of the present disclosure formed of a blend of a first material and a second material that is substantially immiscible in the first material. In FIG. 2, an optical film 201 is formed of a continuous (matrix) phase 203 and a disperse (discontinuous) phase 207. The continuous phase may comprise the first material and the second phase may comprise the second material. The optical properties of the film may be used to form a diffusely reflective polarizing film. In such a film, the refractive indices of the continuous and disperse phase materials are substantially matched along one in-plane axis and are substantially mismatched along another in-plane axis. Generally, one or both of the materials are capable of becoming positively birefringent as a result of calendering or stretching under the appropriate conditions. In the diffusely reflective polarizer, such as that shown in FIG. 2, it is desirable to match the refractive indices of the materials in the direction of one in-plane axis of the film as close as possible while having as large of a refractive indices mismatch as possible in the direction of the other in-plane axis.

If the optical film is a blend film including a disperse phase and a continuous phase as shown in FIG. 2 or a blend film including a first co-continuous phase and a second co-continuous phase, many different materials may be used as the continuous or disperse phases. Such materials may include inorganic materials such as silica-based polymers, organic materials such as liquid crystals, and polymeric materials, including monomers, copolymers, grafted polymers, and mixtures or blends thereof. The materials selected for use as the continuous and disperse phases or as co-continuous phases in the blend optical film having the properties of a diffusely reflective polarizer may, in some exemplary embodiments, include at least one optical material that is orientable under the processing conditions to introduce birefringence and at least one material that does not appreciably orient under the processing conditions and does not develop an appreciable amount of birefringence. Other exemplary materials useful as the minor or disperse phase in a blended optical film include negatively birefringent polymers such as syndiotactic polystyrene (sPS) and syndiotactic polyvinyl naphthalene.

Details regarding materials selection for blend films are set forth in U.S. Pat. Nos. 5,825,543 and 6,590,705, both incorporated by reference. Suitable materials for the continuous phase (which also may used in the disperse phase in certain constructions or in a co-continuous phase) may be amorphous, semicrystalline, or crystalline polymeric materials, including materials made from monomers based on carboxylic acids such as isophthalic, azelaic, adipic, sebacic, dibenzoic, terephthalic, 2,7-naphthalene dicarboxylic, 2,6-naphthalene dicarboxylic, cyclohexanedicarboxylic, and bibenzoic acids (including 4,4′-bibenzoic acid), or materials made from the corresponding esters of the aforementioned acids (i.e., dimethylterephthalate). Of these, 2,6-polyethylene naphthalate (PEN), copolymers of PEN and polyethylene terepthalate (PET), PET, polypropylene terephthalate, polypropylene naphthalate, polybutylene terephthalate, polybutylene naphthalate, polyhexamethylene terephthalate, polyhexamethylene naphthalate, and other crystalline naphthalene dicarboxylic polyesters. PEN, PET, and their copolymers are especially preferred because of their strain induced birefringence, and because of their ability to remain permanently birefringent at elevated environmental temperatures.

Suitable materials for the second polymer in some film constructions include materials that are substantially non-positively birefringent when oriented under the conditions used to generate the appropriate level of birefringence in the first polymeric material. Suitable examples include polycarbonates (PC) and copolycarbonates, polystyrene-polymethylmethacrylate copolymers (PS-PMMA), PS-PMMA-acrylate copolymers such as, for example, those available under the trade designations MS 600 (50% acrylate content) from Sanyo Chemical Indus., Kyoto, Japan, NAS 21 (20% acrylate content) and NAS 30 (30% acrylate content) from Nova Chemical, Moon Township, Pa., polystyrene maleic anhydride copolymers such as, for example, those available under the trade designation DYLARK from Nova Chemical, acrylonitrile butadiene styrene (ABS) and ABS-PMMA, polyurethanes, polyamides, particularly aliphatic polyamides such as nylon 6, nylon 6,6, and nylon 6,10, styrene-acrylonitrile polymers (SAN) such as TYRIL, available from Dow Chemical, Midland, Mich., and polycarbonate/polyester blend resins such as, for example, polyester/polycarbonate alloys available from Bayer Plastics under the trade designation Makroblend, those available from GE Plastics under the trade designation Xylex, and those available from Eastman Chemical under the trade designation SA 100 and SA 115, polyesters such as, for example, aliphatic copolyesters including CoPET and CoPEN, polyvinyl chloride (PVC), and polychloroprene.

In one aspect, the present disclosure is directed to a method of making a roll of wide optical film useful, for example, in an optical display, in which the block axis of the film is generally aligned with the length of the roll. Rolls of this film, typically a reflective optical film such as a reflective polarizing film, may be easily laminated to rolls of other optical films that have a block state axis along their length.

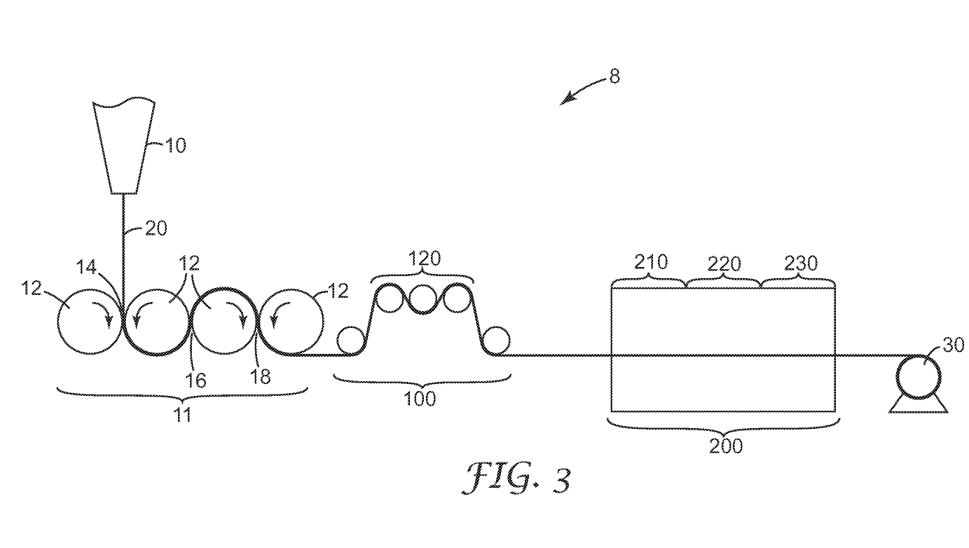

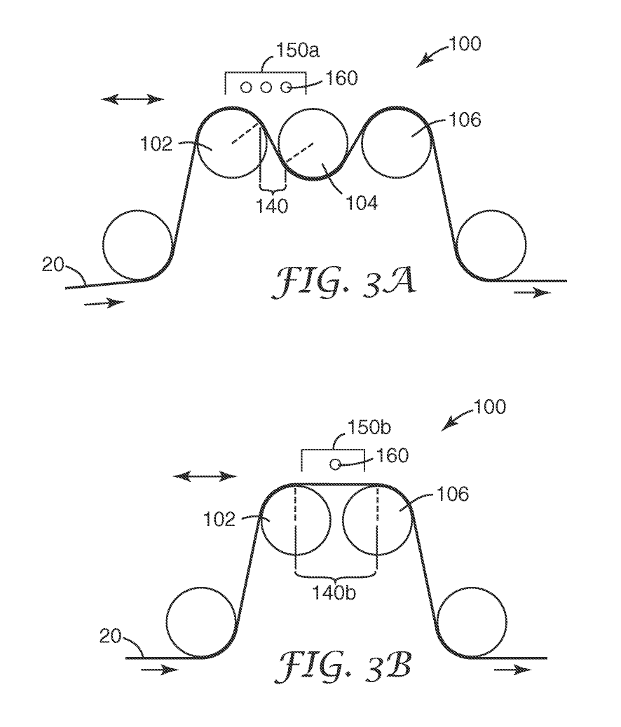

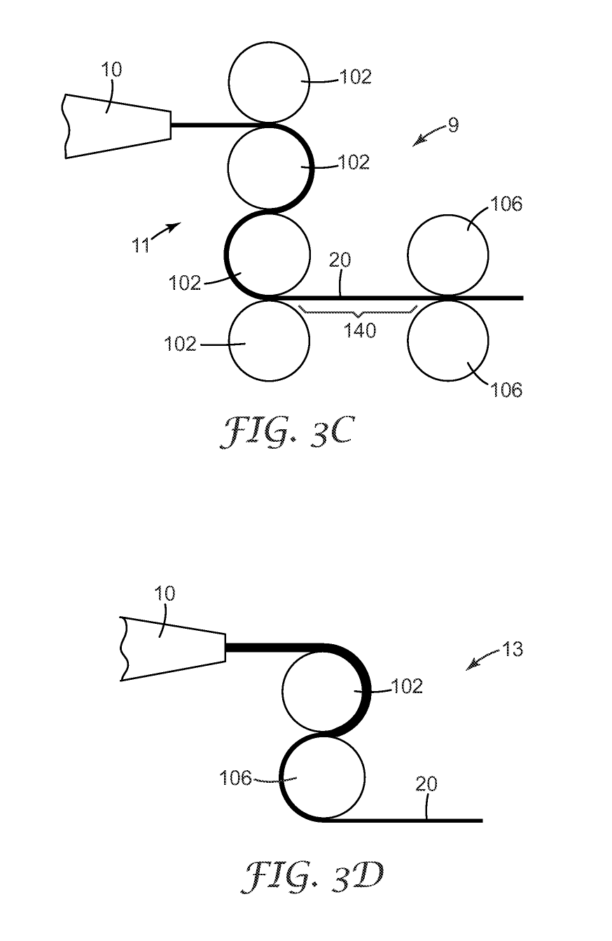

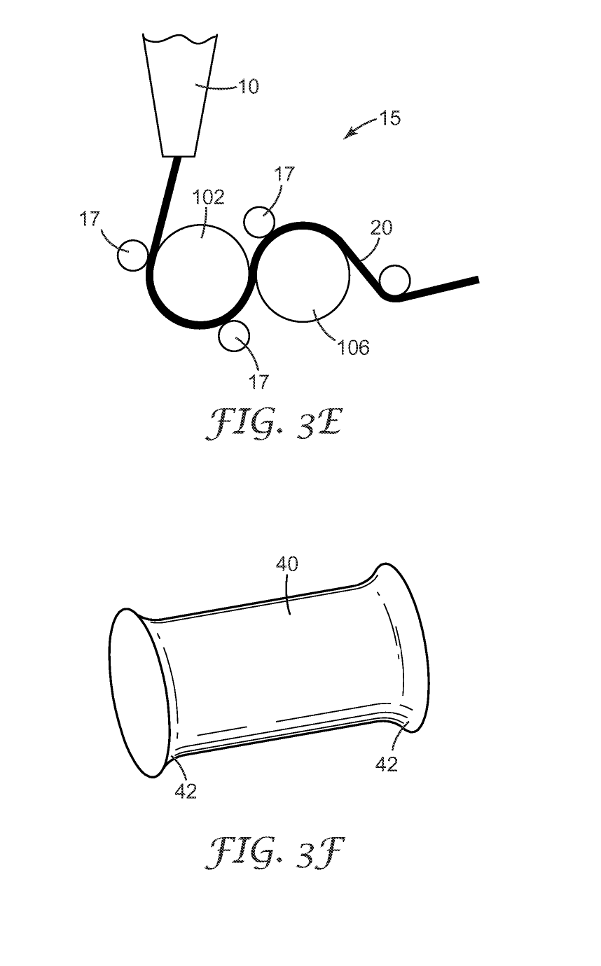

FIG. 3 is a schematic diagram of a film line 8 using a calender 11, length orienter 100 (LO), and tenter oven 200 for forming and orienting polymeric film 20. The calendering process of the present disclosure is suitable for most constructions of optical films, including but not limited to multilayer optical films (MOF) and diffuse reflective polarizing films (DRPF).

To impart particular optical and/or physical characteristics to the finished film, polymer can be extruded through a film die 10, the orifice of which is usually controlled by a series of die bolts. A continuous film 20 formed by the extruder die 10 is forwarded without drawing to a pair of temperature-controlled calender rolls 12 acting cooperatively. The extruded film 20 is calendered at nip 14 between the cooperating calender rolls 12. In some embodiments, the film is calendered while it is still in a molten state. A description of one type of calender 11 that may be used may be found in the U.S. Pat. No. 4,734,229, hereby incorporated by reference, including the structures of the devices and their modes of operation. Other calenders of different design may alternatively be used.

In film line 8 and other film lines of the present disclosure, the temperature of the film 20 may be controlled during processing by controlling the temperature of the rolls and other means. The glass transition temperature (Tg) of a polymer is the temperature at which a polymer transitions from a glassy to a rubbery state, as measured by differential scanning calorimetry (DSC). In some embodiments, the polymer film temperature in the calender is at least slightly above (e.g., by a few degrees) the Tg of at least one and preferably all components of the film. In other embodiments, the polymer film temperature in the calender is from about 10° to about 50° above the Tg of at least one and preferably all components of the film. In yet other embodiments, the polymer film temperature in the calender is from about 30° to about 50° above the Tg of at least one and preferably all components of the film. In still yet other embodiments, the polymer film temperature in the calender is approximately at or below the Tg of all components of the film. In some cases, the calendering still imparts compressive pressures on the film, but the structure of the film is preserved.

In an exemplary embodiment, suitable for blend film constructions such as for DRPF, the extruder is run at a faster rate than the calender rolls 12 initially, to build up a rolling bank of excess polymer material above initial nip 14. The rolling bank can lead to improved uniformity in the composition of the material because of increased mixing. A rolling bank may also result in increased shear being experienced in a blend film construction. A rolling bank can also be used with layered film constructions such as MOF; if layered films are provided with external skins, a rolling bank can be used without disturbing the interior optical layers.

The rolling bank on a calender provides a buffer to keep a uniform supply of material to the calender rolls. Generally a rolling bank can contribute toward the smoothing or elimination of die lines in a final film product. However, if the bank is not maintained at proper level, nonuniformities can appear in the calendered sheet. For example, if the bank is too low, voids can be formed in the sheet due to the “starved” condition of the bank. On the other hand, if the bank is too large, problems such as material scorching can occur, which produces cured or otherwise undesirable lumps in the sheet of material. In addition, variation in rolling bank size causes variation in the spreading force on the rolls resulting in uneven gauge of the sheet. Fluid material from the rolling bank flows through the nip 14 between the calendering rolls 12.

In an exemplary embodiment, film 12 travels through additional nips 16 and 18 of additional calendering rolls 12 before emerging from the calender 11. While four calender rolls 12 are shown, it is understood that more or fewer calender rolls 12 may be used, as desired for a particular application. Generally, at least two calender rolls 12 are used, forming a nip 14 therebetween. In many embodiments, the final calender roll 12 is cooled in order to quench the film 20 below the Tg of its major phase components upon completing calendering.

While some orientation may be imparted to the film 20 during the calendering process, the calendered film 20 may additionally be subsequently oriented, for example by stretching, at ratios determined by the desired properties. Longitudinal stretching can be done by pull rolls in a longitudinal stretch zone 120 of a length orienter (LO) 100, as shown in FIG. 3. The length orienter typically has one or more longitudinal stretch zones. In some exemplary embodiments, four or five pull rolls may be used to stretch the film. However, the configuration of the longitudinal stretch zone 120 may vary as discussed in further detail elsewhere in this disclosure.

In one embodiment, stretching in the transverse direction, and optionally, machine direction, can be accomplished in a tenter oven 200 shown in FIG. 3. The tenter oven 200 typically contains at least a preheat zone 210 and a stretch zone 220. Often the tenter oven 200 also contains a heat set zone 230, as shown in FIG. 3. Heat setting is described in commonly owned copending U.S. patent application Ser. No. 11/397,992, filed on Apr. 5, 2006, entitled “Heat Setting Optical Films,” herein incorporated by reference.

Systems can be designed to contain one or more of any or all of these mechanisms of calender, length orienter, and/or tenter oven. Moreover, the order of the mechanism may be changed. In exemplary embodiments, the last mechanism before winding roll 30 includes a mechanism for imparting MD orientation to the film, whether that mechanism is a calender 11, an LO station 100, or a biaxial tenter oven 220. For example, one system may use calender 11 and LO station 100 without tenter oven 200. Another system may use calender 11, tenter oven 200 (whether for simultaneous biaxial or transverse stretching), and then LO station 100. Yet another system may use calender 11 and simultaneous biaxial tenter oven 220 without LO station 100.

After processing, film 20 can be wound on winding roll 30. In one aspect, the present disclosure is directed to a method of making a roll of wide optical film useful, for example, in an optical display, in which the block axis of the film is generally aligned with the length of the roll. Rolls of this film, typically a reflective optical film such as a reflective polarizing film, may be easily laminated to rolls of other optical films such as absorbing polarizers that have a block state axis along their length.

A film 20 may be laminated with or have otherwise disposed thereon a structured surface film such as those available under the trade designation BEF from 3M Company of St. Paul, Minn. In an exemplary embodiment, the structured surface film includes an arrangement of substantially parallel linear prismatic structures or grooves. In some exemplary embodiments, the optical film may be laminated to a structured surface film including an arrangement of substantially parallel linear prismatic structures or grooves. In an exemplary embodiment, the grooves are aligned along the MD direction, with the block axis of a reflective polarizer film. In other exemplary embodiments, the structured surface may include any other types of structures, a rough surface or a matte surface. Such exemplary embodiments may also be produced by inclusion of additional steps of coating a curable material onto the film 20, imparting surface structures into the layer of curable material and curing the layer of the curable material.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a polymer comprising dichroic dye material or coated with a polyvinyl alcohol-containing (PVA) layer prior to the second draw step.

For uniaxial stretching, stretch ratios of approximately 3:1 to 10:1 are common. Those skilled in the art will understand that other stretch ratios may be used as appropriate for a given film.

For the purpose of this application, the term “transverse stretch zone” refers to either a purely transverse stretch zone or a simultaneous biaxial stretch zone in a tenter oven. By “tenter”, we mean any device by which film is gripped at its edges while being conveyed in the machine direction. Typically, film is stretched in the tenter. In some embodiments, the stretching direction in a tenter with diverging rails along which the grippers travel will be perpendicular to the machine direction (the stretching direction will be the transverse direction or cross-web direction), but other stretching directions, for example at angles other than the angle perpendicular to film travel, are also contemplated.

Optionally, in addition to stretching the film in a first direction that is other than the machine direction, the tenter may also be capable of stretching the film in a second direction, either the machine direction or a direction that is close to the machine direction. Second direction stretching in the tenter may occur either simultaneously with the first direction stretching, or it may occur separately, or both. Stretching within the tenter may be done in any number of steps, each of which may have a component of stretching in the first direction, in the second direction, or in both. A tenter can also be used to allow a controlled amount of transverse direction relaxation in a film that would shrink if not gripped at its edges. In this case, relaxation takes place in a relaxation zone.

A common industrially useful tenter grips the two edges of the film with two sets of tenter clips. Each set of tenter clips is driven by a chain, and the clips ride on two rails whose positions can be adjusted in such a way that the rails diverge from one another as one travels through the tenter. This divergence results in a cross-direction stretch. Variations on this general scheme are contemplated herein.

Some tenters are capable of stretching film in the machine direction, or a direction close to the machine direction, at the same time they stretch the film in the cross-direction. These are often referred to as simultaneous biaxial stretching tenters. One type uses a pantograph or scissors-like mechanism to drive the clips. This makes it possible for the clips on each rail to diverge from their nearest-neighbor clips on that rail as they proceed along the rail. Just as in a conventional tenter, the clips on each rail diverge from their counterparts on the opposite rail due to the divergence of the two rails from one another.

Another type of simultaneous biaxial stretching tenter substitutes a screw of varying pitch for each chain. In this scheme, each set of clips is driven along its rail by the motion of the screw thread, and the varying pitch provides for divergence of the clips along the rail. In yet another type of simultaneous biaxial stretching tenter, the clips are individually driven electromagnetically by linear motors, thus permitting divergence of the clips along each rail. A simultaneous biaxial stretching tenter can also be used to stretch in the machine direction only. In this case, machine direction stretching takes place in a machine direction stretch zone. In this application, transverse direction stretching, relaxation, and machine direction stretching are examples of deforming, and transverse stretch zone, relaxation zone, or machine direction stretch zone are examples of deformation zones. Other methods for providing deformation in two directions within a tenter may also be possible, and are contemplated by the present application.

The film 20 provided into calender 11 may be a solvent cast or an extrusion cast film. In the embodiment illustrated in FIG. 3, the film 20 is an extruded film expelled from an extruder die 10 and including at least one, and preferably two polymeric materials. The optical film 20 may vary widely depending on the intended application, and may have a monolithic structure as shown in FIG. 1A, a layered structure as shown in FIG. 1B, or a blend structure as shown in FIG. 2, or a combination thereof.

In an exemplary embodiment, the die 10 lip profile is adjustable with a series of die bolts. For multilayer films, multiple melt streams and multiple extruders are employed. To orient the film, the film or cast web is calendered and stretched in the machine direction, transverse direction, or both depending on desired properties of the finished film. Film processing details are described, for example in U.S. Pat. No. 6,830,713 (Hebrink et al.), hereby incorporated by reference. For simplicity, the present specification shall use the term “film” to denote film at any stage of the process, without regard to distinctions between “extrudate,” “cast web” or “finished film.” However, those skilled in the art will understand that film at different points in the process can be referred to by the alternate terms listed above, as well as by other terms known in the art.

The term orient as used herein refers to a process step in which the film dimensions are changed and molecular orientation is induced in the polymeric materials making up the film. In an exemplary embodiment, the materials selected for use in the optical film 20 are preferably free from any undesirable orientation prior to the disclosed process. Alternatively, deliberate orientation can be induced during the casting or extrusion step as a process aid. The materials in the film 20 are selected based on the end use application of the optical film, which in one example will become birefringent and may have reflective properties such as reflective polarizing properties. In one exemplary embodiment described in detail in this application, the optically interfaced materials in the film 20 are selected to provide a film with the properties of a reflective polarizer.

FIGS. 3A and 3B are schematic diagrams of two embodiments of film threading in length orienter station 100. In a typical LO station 100, at least four rolls are used to form at least two grip points for film 20. In other embodiments, fewer rolls can be used if other gripping means are employed. It should be understood that in some configurations, a single roll can serve as both a calender roll and an LO pull roll. In FIG. 3A, pull rolls 102, 104, and 106 are set up in an S-wrap configuration. In FIG. 3B, the pull rolls 102 and 106 are set up in a straight, normal or tabletop configuration. In exemplary embodiments, in relative terms, roll 102 rotates slowly, roll 106 rotates quickly, and roll 104 may rotate at the rate of roll 106 or at a rate intermediate to those of rolls 102 and 106. In exemplary embodiments, in relative terms, roll 102 is heated and roll 106 is cooled, such as by quenching. Generally, in these and other rolls of the present disclosure, the temperature of a roll may be controlled by circulation of a heat transfer fluid, such as oil or water, inside a hollow roll.

Film 20 is conveyed through a series of temperature-controlled rollers 102, 104, 106 to a draw gap 140, 140b. The film 20 is drawn due to the differences in speed between the initial and final rollers defining the draw gap 140, 140b. Film may also be drawn in the gap between rolls 104 and 106 in the length orienter station 100 of FIG. 3A. Typically, the film 20 is heated with infrared radiation as it spans the gap 140, 140b to soften the film 20 and facilitate the drawing above the glass transition temperature. The embodiments depicted in FIGS. 3A and 3B employ heating assemblies 150a-b for providing a distribution of heat to the longitudinal stretch zone 140 or 140b of the film 20. If a stretch zone exists between rolls 104 and 106 of FIG. 3A, a heating assembly may be employed there as well. In some embodiments, the temperature of the film 20 while undergoing length orientation is from about 10° to about 50° above the Tg of at least one and preferably all components of the film. In other embodiments, the temperature of the film 20 while undergoing length orientation is from about 10° to about 30° above the Tg of at least one and preferably all components of the film. In yet other embodiments, the temperature of the film 20 while undergoing length orientation is below the Tg of all components of the film.

In the embodiment shown in FIG. 3A, the heating assembly 150a comprises three transverse infrared heating elements 160. Although this particular embodiment illustrates a set of three heating elements 160, one, two, or any number of heating elements can be used, depending on the design considerations of the system. For example, a system having a single heating element (heating assembly 150b) is shown in FIG. 3B. Each transverse heating element 160 can be a single heater spanning the entire width of the film area to be controlled, or a plurality of smaller heaters, including point sources of heat, arranged to provide the desired amount of heat to the film area to be controlled. Combinations of point sources and extended sources of heat are also contemplated. The heating process could also incorporate hot air impingement from nozzles.

In an exemplary embodiment, the high pressure calender rolls 12 advantageously remove die lines from the resulting film 20. Die or flow lines are a common cosmetic film defect generated from imperfections in the extrusion die or build-up on the die lips. Compression provided by the hot pressured calender rolls 12 of calender 11 will squeeze and flatten the die lines, thus minimizing and even eliminating their undesirable effects. In an exemplary embodiment, a film 20 resulting from a calender process of the present invention exhibits an absence of die lines.

In an exemplary embodiment, the high pressure calender rolls 12 also uniformly flatten the film 20. The process of squeezing molten polymer between uniformly parallel heated calender rolls 12 aids in eliminating cross web caliper variation generated by an extrusion die 10 that can be magnified in typical length orientation processes. In an exemplary embodiment, an optical film 20 formed according to the present disclosure exhibits a caliper variation over the useful film area of less than 5% (+/−2.5%), preferably less than 3.5% (+/−1.75%), less than 3% (+/−1.5%) and more preferably less than 1% (+/−0.5%) of the average thickness of the film.

For blended reflective polarizers, (as shown in FIG. 2), the high shear rates of the calendering process can create higher birefringence in the major or continuous phase 203 of a film. This effect is especially beneficial when the disperse phase 207 polymer particles are negatively birefringent. The combined effect of high shear from heated calender roll 12 compression while simultaneously elongating the film 20 in the machine direction can provide increased polymer orientation and thus higher levels of birefringence. Some polymers also retain a certain amount of melt orientation as they are extruded out of a die 10. Orienting birefringent polymers in the same direction as they are extruded can multiply the degree of polymer orientation and thus create higher levels of birefringence. Useful values of normalized refractive index difference along the MD that are expected to be obtained with exemplary embodiments of the present disclosures include 0.09 or higher, 0.1 or higher, 0.15 or higher, 0.2 or higher, or even 0.32 or higher. The combined effect of high shear rates and orientation in the same machine direction as melt orientation can also improve the dichroic ratio of extrudable dichroic dyes for making polarizers.

Calendering processes are also capable of making thick optical films at very high line speeds. Thicker films are advantageous for warp resistance in larger Liquid Crystal Displays. An exemplary optical film made by a calendering process of the present disclosure is at least 200 micrometers thick or thicker and more preferably at least 250 micrometers thick or thicker. An exemplary calendering process of the present disclosure is run at a line speed greater than 100 feet/minute (30.5 m/min) and more preferably greater than 150 feet/minute (45.7 m/min).

While a particular order is exemplified for the various processes described in this disclosure, the order is used to facilitate an explanation and is not intended to be limiting. In certain instances the order of the processes can be changed or performed concurrently as long as subsequently performed processes do not adversely affect previously performed processes. Moreover, different processing line configurations can also be used.

FIG. 3C is a schematic diagram of a portion of another film line 9 of the present disclosure. As shown in film line 9, heated slow rolls 102 also act as calender rolls. In this example, extruder 10 supplies the polymer melt curtain feed for film 20 from the side; this is possible because visco-elastic forces overcome the forces of gravity. In the illustrated example, stretch zone 140 follows calender 11 immediately, without other intervening pull rolls. Quenched fast rolls 106 stretch film 20 across stretch zone 140. Whereas in some embodiments, the film is cooled below Tg after calendering and subsequently reheated before a stretching operation, in these embodiment, the polymer film temperature is typically maintained above the Tg of at least one and preferably all components of the film during both calendering and stretching, followed by quenching with rolls 106. In other embodiments employing the film line 9 of FIG. 3C, the film temperature may be below Tg for any processing step. Other portions of the film line 9 may be as illustrated in FIG. 3.

FIG. 3D is a schematic diagram of a portion of yet another embodiment of a film line 13 of the present disclosure. In film line 13, compression and elongation of film 20 are performed simultaneously by slow roll 102 and fast roll 106, which also act as calender rolls 12. In some embodiments, the temperature of slow roll 102 may be controlled to maintain the film above the Tg of at least one and preferably all components of the film, while fast roll 106 may be quenched. Other portions of the film line 13 may be as illustrated in FIG. 3.

FIG. 3E is a schematic diagram of a portion of yet another embodiment of a film line 15 of the present disclosure. In film line 15, length orientation of film 20 results from the difference in speeds between roll 102 and roll 106. Rolls 102 and 106 may also act as calender rolls, depending on the spacing maintained therebetween. Additionally, nip rolls 17 may be added as shown. The nip rolls 17 may serve to isolate the stretching between rolls 102 and 106. In addition, at any nip formed between a nip roll 17 and one of rolls 102 or 106, calendering may be performed, depending on the spacing maintained between the rolls. The portion of film line 15 shown in FIG. 3E may be configured to accomplish the tasks of casting, calendering, and orienting film 20 in a simplified process. In exemplary embodiments, rolls 102, 106 and 17 are pneumatically actuated, rubber covered roll assemblies using solenoid valves and pressure regulators. In exemplary embodiments, each roll 102, 106 has an outside diameter of about 30 inches (76.2 cm) and each nip roll 17 has an outside diameter of about 4 inches (10.2 cm). Other portions of the film line 15 may be as illustrated in FIG. 3.

In some exemplary embodiments, the temperature of rolls 102 and 106 are controlled to maintain the film at a temperature above the Tg of its major phase components during calendering and orienting operations. In some embodiments, both rolls 102 and 106 can be held at a temperature at or below the Tg of the major phase components of the film 20. In other embodiments, the temperature of roll 102 can be held at or just below the Tg of a major phase component of the film 20, while the temperature of roll 106 can be held about 5° C. to about 150° C. below the Tg of a major phase component of the film 20. In some embodiments, the major phase components of the film 20 are quenched below Tg by roll 106 upon completing processing by the portion of film line 15 depicted in FIG. 3E.

In some embodiments, rolls 102 and 106 can be separated by a draw gap. As the film 20 is stretched between the rolls in the machine direction, it can experience neck-down, decreasing in width in the transverse direction. A phenomenon accompanying neck-down can be an increase in the thickness of the film at its edges.

To counter the increase of edge thickness, whether or not it is associated with neck-down during length orientation, a varying thickness profile across the transverse direction may be imparted to a film prior to length orientation to compensate for the edge thickening. FIG. 3F is a schematic illustration of a roll 40 that may be used to impart such a thickness profile. The roll 40 has a non-constant diameter across its width in the transverse direction. As illustrated, roll 40 has profiling regions 42 that act to thin the film at the film's edges during a calendering operation. When the film is subsequently length oriented, the thinner edges may compensate for the increase in edge thickness accompanying neck-down, resulting in a more consistent thickness across the width of the film after orientation. Roll 40 may be a casting roll, calendering roll, nip roll, or any other roll suitable for imparting a thickness profile to a film prior to length orientation. In some embodiments, as depicted schematically in FIG. 3E, one or more of rolls 17 preceding the potential draw gap between rolls 102 and 106 is a roll of the type exemplified by roll 40 of FIG. 3F. Note that in FIG. 3F, profiling regions 42 are merely shown schematically. A variety of factors such as material properties and manufacturing parameters will influence edge thickening, and hence, the actual shapes used for profiling regions 42, which may be determined by modeling or empirical studies. Most generally, the roll 40 may be designed with an arbitrary varying diameter profile across its width to result in a desired thickness profile of the final film, whether that desired thickness profile is a uniform thickness or an intentionally varying thickness.

The disclosed rolls may be smooth or structured for imparting a pattern to a film. For example, a gain diffuser surface structure such as one disclosed in co-assigned and co-pending U.S. patent application Ser. No. 11/735,684 could be imparted to a film, or any other pattern that may contribute optical, mechanical, or other functionality to a film. Any of the disclosed rolls may have a fluorochemical or silicone based release coating. Another possible roll surface is Teflon impregnated ceramic.

A film produced by the processes disclosed herein may optionally be treated by applying any or all of corona treatments, primer coatings or drying steps in any order to enhance its surface properties for subsequent lamination steps. The optical film may be laminated to or otherwise combined with a wide variety of materials to make various optical constructions, some of which may be useful in display devices.

For example, any of the polarizing films described above may be laminated with or have otherwise disposed thereon a structured surface film such as those available under the trade designation BEF from 3M Company of St. Paul, Minn. In a preferred embodiment, the structured surface film includes an arrangement of substantially parallel linear prismatic structures or grooves. In some exemplary embodiments, the optical film may be laminated to a structured surface film including an arrangement of substantially parallel linear prismatic structures or grooves. The grooves may be aligned along the crossweb (TD) direction with the transmission or pass axis of a reflective polarizer film. In other exemplary embodiments, the structured surface may include any other types of structures, a rough surface or a matte surface. Such exemplary embodiments may also be produced by inclusion of additional steps of coating a curable material onto the optical film of the present disclosure imparting surface structures into the layer of curable material and curing the layer of the curable material. Another exemplary embodiment includes a coating comprising refractive index matched beads which protrude from the coating and create hemispheric protrusions on the surface.

Since exemplary reflective polarizers made according to the processes described herein have a block axis along the downweb (MD) direction, the reflective polarizers may simply be roll-to-roll laminated to any length oriented polarizing film. In other exemplary embodiments, the film may be coextruded with a polymer comprising a dichroic dye material or coated with a PVA-iodine containing layer prior to the second draw step. FIG. 4 illustrates an optical film construction 400 in which a first optical film 401, such as a reflective polarizer with a block axis along a direction 405 and a transmission or pass axis along a direction 406, is combined with a second optical film 403. The second optical film 403 may be another type of optical or non-optical film such as, for example, an absorbing polarizer, with a block axis along a direction 404.

In the construction shown in FIG. 4, the block axis 405 of the reflective polarizing film 401 is preferably aligned as accurately as possible with the block axis 404 of the dichroic polarizing film 403 to provide acceptable performance for a particular application as, for example, a brightness enhancement polarizer or a display polarizer. Increased mis-alignment of the axes 404, 405 diminishes the gain produced by the laminated construction 400, and makes the laminated construction 400 less useful for display polarizer applications. For example, for a brightness enhancement polarizer the angle between the block axes 404, 405 in the construction 400 should be less than about +/−10°, more preferably less than about +/−5° and more preferably less than about +/−3°.

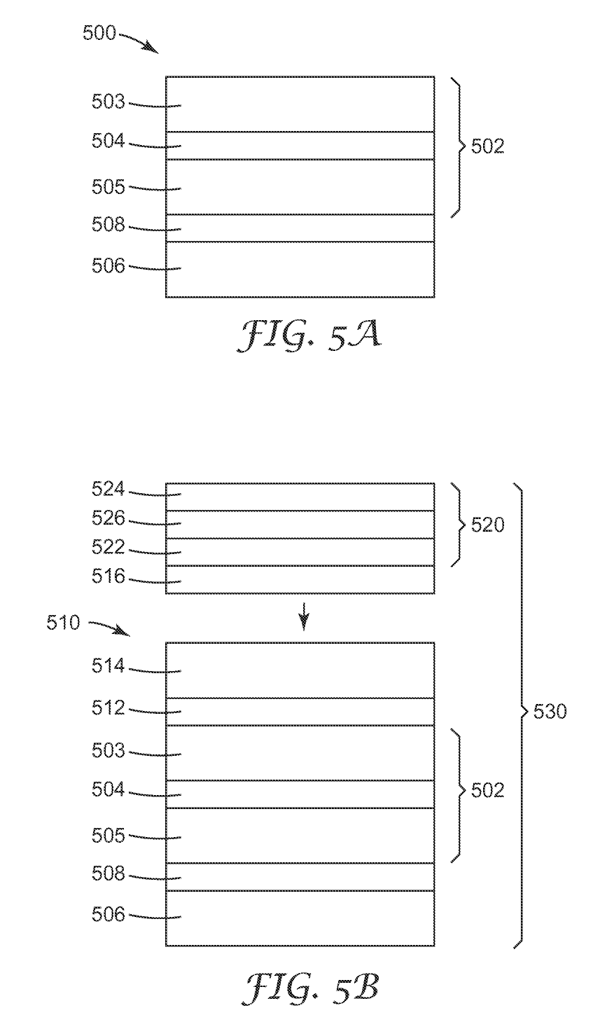

In an embodiment shown in FIG. 5A, a laminate construction 500 includes an absorbing polarizing film 502 with a first protective layer 503. The protective layer 503 may vary widely depending on the intended application, but typically includes a solvent cast cellulose triacetate (TAC) film. The exemplary construction 500 further includes a second protective layer 505, as well as an absorbing polarizer layer 504, such as an iodine-stained PVA (I₂/PVA). The absorbing polarizing film 502 is laminated or otherwise bonded to or disposed on an optical film reflective polarizer 506 (as described herein having an MD block axis), for example, with an adhesive layer 508.

FIG. 5B shows an exemplary polarizer compensation structure 510 for an optical display, in which the laminate construction 500 is bonded to an optional birefringent film 514 such as, for example, a compensation film or a retarder film, with an adhesive 512, typically a pressure sensitive adhesive (PSA). In the compensation structure 510, either of the protective layers 503, 505 may optionally be replaced with a birefringent film that is the same or different than the compensation film 514. Such optical films may be used in an optical display 530. In such configurations, the compensation film 514 may be adhered via an adhesive layer 516 to an LCD panel 520 including a first glass layer 522, a second glass layer 524 and a liquid crystal layer 526. This laminate construction enables removal of a layer of TAC film from the polarizer construction.

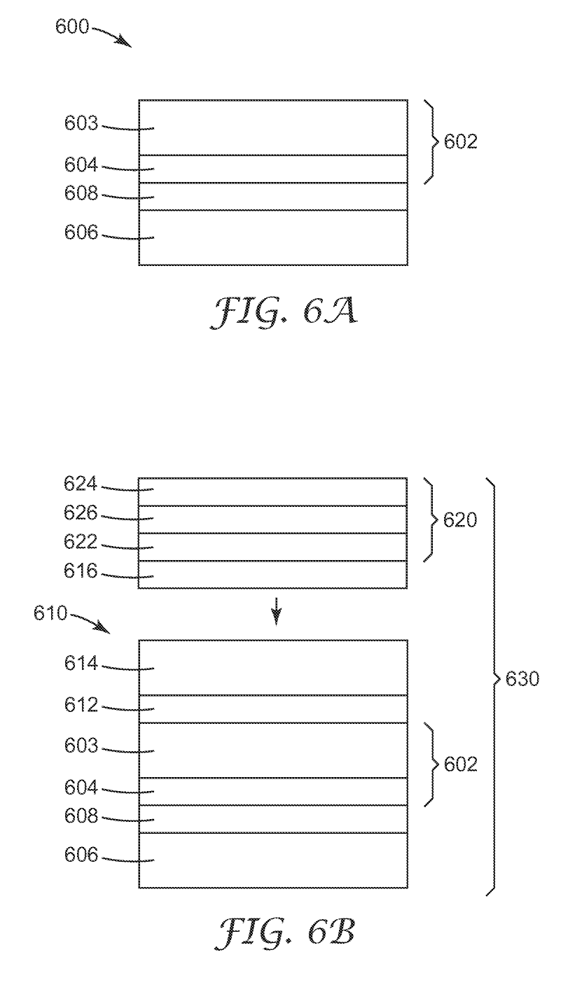

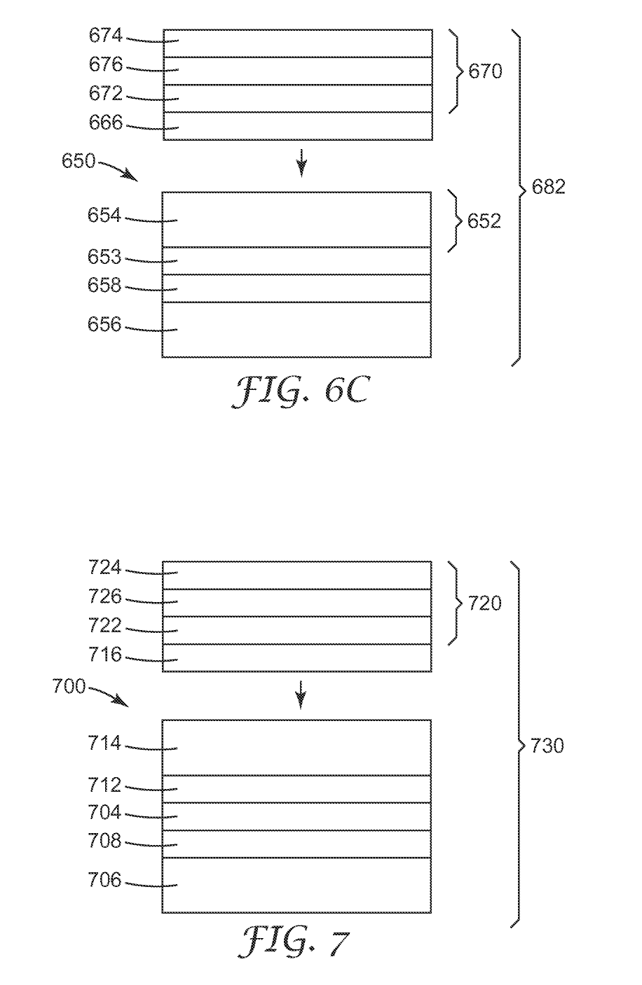

Referring to FIG. 6A, another exemplary laminate construction 600 is shown that includes an absorbing polarizing film 602 having a single protective layer 603 and an absorbing polarizing layer 604, e.g., a I₂/PVA layer. The absorbing polarizing film 602 is bonded to an MD polarization axis optical film reflective polarizer 606, for example, with an adhesive layer 608. In this exemplary embodiment, the block axis of the absorbing polarizer is also along the MD. Elimination of either or both of the protective layers adjacent to the absorbing polarizer layer 604 can provide a number of advantages including, for example, reduced thickness, reduced material costs, and reduced environmental impact (solvent cast TAC layers not required).

FIG. 6B shows a polarizer compensation structure 610 for an optical display, in which the laminate construction 600 is bonded to an optional birefringent film 614 such as, for example, a compensation film or a retarder film, with an adhesive 612. In the compensation structure 610, the protective layer 603 may optionally be replaced with a birefringent film that is the same or different than the compensation film 614. Such optical films may be used in an optical display 630. In such configurations, the birefringent film 614 may be adhered via an adhesive layer 616 to an LCD panel 620 including a first glass layer 622, a second glass layer 624 and a liquid crystal layer 626.

FIG. 6C shows another exemplary polarizer compensation structure 650 for an optical display. The compensation structure 650 includes an absorbing polarizing film 652 with a single protective layer 653 and an absorbing polarizer layer 654, such as a I₂/PVA layer. The absorbing polarizing film 652 is bonded to an MD block axis reflective polarizer 656, for example, with an adhesive layer 658. In the compensation structure 650, the protective layer 653 may optionally be replaced with a compensation film. To form an optical display 682, the absorbing polarizer layer 654 may be adhered via adhesive layer 666 to an LCD panel 670 including a first glass layer 672, a second glass layer 674 and a liquid crystal layer 676.

FIG. 7 shows another exemplary polarizer compensation structure 700 for an optical display, in which the absorbing polarizing film includes a single absorbing (e.g., I₂/PVA) layer 704 without any adjacent protective layers. One major surface of the layer 704 is bonded to an MD block axis optical film reflective polarizer 706 such that the block axis of the absorbing polarizer is also along MD. Bonding may be accomplished with an adhesive layer 708. The opposite surface of the layer 704 is bonded to an optional birefringent film 714 such as, for example, a compensation film or a retarder film, with an adhesive 712. Such optical films may be used in an optical display 730. In such exemplary embodiments, the birefringent film 714 may be adhered via adhesive layer 716 to an LCD panel 720 including a first glass layer 722, a second glass layer 724 and a liquid crystal layer 726.

The adhesive layers in FIGS. 5-7 above may vary widely depending on the intended application, but pressure sensitive adhesives and H₂O solutions doped with PVA are expected to be suitable to adhere the I₂/PVA layer directly to the reflective polarizer. Optional surface treatment of either or both of the reflective polarizer film and the absorbing polarizer film using conventional techniques such as, for example, air corona, nitrogen corona, other corona, flame, or a coated primer layer, may also be used alone or in combination with an adhesive to provide or enhance the bond strength between the layers. Such surface treatments may be provided in-line with the first and second draw steps and may be prior to the first draw step, prior to the second draw step, subsequent to the first and second draw steps or subsequent to any additional draw steps. One exemplary adhesive layer is a coextruded or coated copolyester comprising sufficient polar salt comonomers such as sodium sulfonated isophthalate to make the copolyester at least partially water soluble.

The instances described below include exemplary materials and processing conditions in accordance with different embodiments of the disclosure. The descriptions are not intended to limit the disclosure but rather are provided to facilitate an understanding of the invention as well as to provide examples of materials particularly suited for use in accordance with the various above-described embodiments.

Relative gain can be measured with an effective transmission tester. Gain is measured by placing sample films on a diffusely transmissive hollow light box illuminated using a stabilized broadband source. The axial luminance (normal to the plane of the film) is measured through an absorbing polarizer using a SpectraScan™ PR-650 SpectraColorimeter available from Photo Research, Inc, Chatsworth, Calif. Relative gain is calculated by applying a spectral weighting to the luminance measurement and dividing the measured luminance with the sample film in place by the measured luminance without the sample film in place (light box only). This measurement provides stable and reproducible comparative gain values between different film samples.

Haze measurements are made using a BYK Gardner Haze-Gard Plus instrument, catalog no. 4723 and supplied by BYK Gardner, Silver Spring, Md. The instrument is referenced against air during the measurements. The haze levels can be defined according to ASTM-D1003-00, titled “Standard Test Method for Haze and Luminous Transmittance for Transparent Plastics.”

Copolyethylene naphthalate (CoPEN7030) can be synthesized in a batch reactor with the following raw material charge: 112.3 kg dimethyl naphthalene dicarboxylate, 38.2 kg dimethyl terephthalate, 85.6 kg ethylene glycol, 27 g manganese acetate, 27 g cobalt acetate, and 48 g antimony triacetate. Under pressure of 2 atm (2×105 N/m2), this mixture is heated to 254° C. while removing methanol. After 38.9 kg of methanol is removed, 49 g of triethyl phosphonoacetate is charged to the reactor and than the pressure is gradually reduced to 1 torr while heating to 290° C. The condensation reaction by-product, ethylene glycol, is continuously removed until a polymer with an intrinsic viscosity of 0.53 dL/g, as measured in 60/40 wt. % phenol/o-dichlorobenzene, is produced. CoPEN7030 has a Tg of 110 C measured by DSC.

Copolyethylene naphthalate (CoPEN9010) can be synthesized in a batch reactor with the following raw material charge: 126 kg dimethyl naphthalene dicarboxylate, 11 kg dimethyl terephthalate, 75 kg ethylene glycol, 27 g manganese acetate, 27 g cobalt acetate, and 48 g antimony triacetate. Under pressure of 2 atm (2×105 N/m2), this mixture is heated to 254° C. while removing methanol. After 36 kg of methanol is removed, 49 g of triethyl phosphonoacetate is charged to the reactor and than the pressure is gradually reduced to 1 torr while heating to 290° C. The condensation reaction by-product, ethylene glycol, is continuously removed until a polymer with an intrinsic viscosity of 0.50 dL/g, as measured in 60/40 wt. % phenol/o-dichlorobenzene, is produced. CoPEN9010 has a Tg of 116 C measured by DSC.

The polyethylene naphthalate (PEN) can be synthesized in a batch reactor with the following raw material charge: dimethyl naphthalene dicarboxylate (136 kg), ethylene glycol (73 kg), manganese (II) acetate (27 g), cobalt (II) acetate (27 g) and antimony (III) acetate (48 g). Under a pressure of 2 atmospheres (1520 torr or 2×10⁵ N/m²), this mixture was heated to 254° C. while removing methanol (a transesterification reaction by-product). After 35 kg of methanol was removed, 49 g of triethyl phosphonoacetate (49 g) was charged to the reactor and the pressure was gradually reduced to 1 torr (131 N/m²) while heating to 290° C. The condensation reaction by-product, ethylene glycol, was continuously removed until a polymer with an intrinsic viscosity of 0.48 dL/g (as measured in 60/40 wt. % phenol/o-dichlorobenzene) was produced. PEN has a Tg of 123 C as measured by DSC.

CoPEN7030 and SA115 (polycarbonate/coPET blend from Eastman) was melt blended in a twin screw extruder at a 60:40 ratio and extruded into a cast web using an extrusion die and calendering process as shown in FIG. 3E. The cast web was compressed with a calendering roll which formed a rolling bank where it nipped with the casting roll. The calendering nip roll temperature was controlled at 55 C, and the casting roll was controlled at a temperature of 112.8 C and a speed of 2.3 meters/min. The second casting roll speed was controlled at a speed of 9.2 meters/min to elongate the film to a draw ratio of 4:1. The resulting blend reflective polarizer provided an increase in brightness or Gain of 1.3 as measured with an effective transmission tester and had a haze level of 74% as measured by a Gardner haze meter. No die lines were observed in this machine direction oriented film.

CoPEN9010 and SA115 (polycarbonate/coPET blend from Eastman) was melt blended in a twin screw extruder at a 60:40 ratio and extruded into a cast web using an extrusion die and calendering process as shown in FIG. 3E. The cast web was compressed with a calendering roll which formed a rolling bank where it nipped with the casting roll. The calendering nip roll temperature was controlled at 55 C, and the casting roll was controlled at a temperature of 118.3 C and a speed of 2.1 meters/min. The second casting roll speed was controlled at a speed of 8.4 meters/min to elongate the film to a draw ratio of 4:1. The resulting blend reflective polarizer provided an increase in brightness or Gain of 1.38 as measured with an effective transmission tester and had a haze level of 67% as measured by a Gardner haze meter. No die lines were observed in this machine direction oriented film.

A multi-layer film with 3 layers having a SA115 core layer and 60:40 ratio of PEN and polycarbonate skin layers was coextruded into a cast web using an extrusion die and calendering process as shown in FIG. 3E. The cast web was compressed with a calendering roll which formed a rolling bank where it nipped with the casting roll. The calendering nip roll temperature was controlled at 55 C, and the casting roll was controlled at a temperature of 118.3 C and a speed of 2.1 meters/min. Microscopic analysis of a cross section of the cast web indicated that only the skin layers formed the rolling bank, and thus did not blend with the core layer, leaving the core layer intact. The second casting roll speed was controlled at a speed of 6.3 meters/min to elongate the film to a draw ratio of 3:1. The resulting blend reflective polarizer provided an increase in brightness or Gain of 1.32 as measured with an effective transmission tester and had a haze level of 77% as measured by a Gardner haze meter. No die lines were observed in this machine direction oriented film.

A multi-layer optical film with 275 alternating layers of CoPEN9010 available from 3M Company and a cycloaliphatic polyester/polycarbonate blend commercially available from Eastman Chemical Co. under the tradename “SA115” can be coextruded into cast web using a multi-manifold feedblock, extrusion die, and nip roll calendering process. The cast web can be cooled to a temperature of 140°-160° C. with the calendering rolls and then compressed 1.1-3.0 times with nip rolls while simultaneously being elongated to a draw ratio of 4-7:1 between the final nip and a set of higher speed cooled nip rolls. The resulting multi-layer reflective polarizer is expected to increase the brightness of a backlit Liquid Crystal Display.

PEN and dichroic dyes such as PD-318H, PD-325H, PD-335H, and PD-104 from Mitsui Chemical Inc., can be melt blended in a twin screw extruder and cast into a cast web using an extrusion die and calendering process as shown in FIG. 3. The cast web can be cooled to a temperature of 140°-160° C. with the calendering rolls and then compressed 1.1-3 times with nip rolls while simultaneously being elongated to a draw ratio of 4-7:1 between the final nip and a set of higher speed cooled nip rolls. The resulting film may be used as a polarizer in a backlit Liquid Crystal Display. Furthermore, the resulting film can be coextruded and oriented with a blend and/or multi-layer reflective polarizer as provided above to create a combined reflecting and absorbing polarizer for use in a backlit Liquid Crystal Display.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method of making an optical film, comprising:
calendering at least one polymeric material; and
stretching the at least one polymeric material along a downweb (MD) direction, thereby creating birefringence in the polymeric material.

2. The method of claim 1, wherein a polymeric material temperature during the calendering step is slightly above a Tg of the polymeric material.

3. The method of claim 1, wherein a polymeric material temperature during the calendering step is at least about 10° C. above a Tg of the polymeric material.

4. The method of claim 1, wherein the optical film is more than 0.3 m wide following the stretching step.

5. The method of claim 1, wherein the optical film is a reflective polarizer film.

6. The method of claim 1, wherein the optical film is a dichroic polarizer.

7. The method of claim 1, wherein the calendering step is performed while simultaneously stretching the film.

8. The method of claim 1, wherein the optical film is simultaneously compressed and elongated.

9. The method of claim 1, wherein the calendering step is performed before the stretching step.

10. The method of claim 1 further comprising extruding the at least one polymeric material from an extruder prior to the calendering step.

11. The method of claim 10, wherein the calendering step comprises calendering the at least one polymeric material in a nip formed between two calendering rolls.

12. The method of claim 11, further comprising forming a rolling bank of the at least one polymeric material at the nip.

13. A method of making an optical film, comprising:
providing a first film comprising:
calendering at least one polymeric material; and
stretching the at least one polymeric material along a downweb (MD) direction, thereby creating birefringence in the polymeric material; and
attaching a second film to the first film.

14. The method of claim 13, wherein the second film is attached to the first film following the calendering and stretching steps.

15. The method of claim 14, wherein the second film is selected from the group consisting of structured surface films, retarders, absorbing polarizing films and a combination thereof.

16. The method of claim 13, wherein attaching the second film to the first film comprises disposing an adhesive between the first film and the second film.

17. The method of claim 13, wherein the second film is coated on the first film.

18. The method of claim 13, further comprising applying a surface treatment to the first film prior to attaching a second film to the first film.

19. The method of claim 18, wherein the surface treatment is selected from corona treatment, drying, applying a primer, or a combination thereof.

20. The method of claim 13, wherein subsequent the calendering and stretching steps, the first film is a reflective polarizer film.

21. The method of claim 13, wherein the second film is coextruded with the first film.

22. The method of claim 13, wherein the first film is a reflective polarizer and the second film is a dichroic polarizer.

23. A method of processing an optical film, comprising calendering a polymeric material comprising a first polymer and a second polymer, wherein the first polymer develops birefringence and the second polymer is substantially isotropic.

24. The method of claim 23 wherein the first and second polymers are disposed in layers.

25. The method of claim 23 wherein the first and second polymers are disposed in a blend.

26. The method of claim 25 wherein the second polymer forms a continuous phase and the first polymer forms a disperse phase within the second polymer.

27. A reflective polarizer made by the process of:
calendering at least one polymeric material; and
stretching the at least one polymeric material along a downweb (MD) direction, thereby creating birefringence in the polymeric material.

28. A roll of optical film comprising an oriented optical film characterized by an effective orientation axis, the oriented optical film comprising only one birefringent polymeric material, the optical film having a width of greater than 0.3 m, a thickness of at least 200 microns and a length a length of at least 10 m, wherein the effective orientation axis is aligned along the length of the optical film.

29. The roll of optical film as recited in claim 28, wherein the optical film has a width of at least 0.65 m.

30. The roll of optical film as recited in claim 28, wherein the optical film has a width of at least 1.3 m.

31. The roll of optical film as recited in claim 28, wherein the optical film has a width of at least 1.8 m.

32. The roll of optical film as recited in claim 28, wherein the optical film has a width of 0.5 m to about 10 m.

33. The roll of optical film as recited in claim 28, wherein the optical film further comprises an absorbing polarizing material layer.

34. The roll of optical film as recited in claim 28, wherein the optical film further comprises at least one retarder layer.

35. The roll of optical film as recited in claim 28, wherein the oriented optical film further comprises at least one isotropic material.

36. The roll of optical film as recited in claim 28, wherein the oriented optical film is a reflective polarizer having a block axis and wherein the block axis is the effective orientation axis.

37. The roll of optical film of claim 28, wherein the optical film has a thickness of at least 250 micrometers.

38. The roll of optical film of claim 28, wherein the optical film comprises a first polymeric material and a second polymeric material, and wherein a normalized refractive index difference along the length of the optical film (MD) between the first polymeric material and the second polymeric material is more than about 0.06.

39. A roll of optical film comprising an oriented optical film, the oriented optical film comprising a first birefringent material characterized by an effective orientation axis and a second birefringent material characterized by an effective orientation axis, wherein the optical film has a width of greater than 0.3 m, a thickness of at least 200 microns and a length of at least about 10 m and the effective orientation axes of the first and second birefringent materials are aligned along the length of the optical film.

40. The roll of optical film as recited in claim 39, wherein the oriented optical film is a reflective polarizer having a block axis and wherein the block axis is aligned with the effective orientation axes.

41. The roll of optical film as recited in claim 39, wherein the optical film has a width of at least 0.65 m.

42. The roll of optical film as recited in claim 39, wherein the optical film has a width of at least 1.3 m.

43. The roll of optical film as recited in claim 39, wherein the optical film has a width of at least 1.8 m.

44. The roll of optical film as recited in claim 39, wherein the optical film has a width of 0.5 m to about 10 m.

45. The roll of optical film as recited in claim 39, further comprising a diffuser layer.

46. The roll of optical film as recited in claim 39, further comprising a structured surface.

47. The roll of optical film as recited in claim 46, wherein the structured surface comprises a plurality of linear prismatic structures having grooves.

48. The roll of optical film of claim 39, wherein the optical film has a thickness of at least 250 micrometers.

49. The roll of optical film of claim 39, wherein a normalized refractive index difference along the length of the optical film (MD) between the first polymeric material and the second polymeric material is more than about 0.06.

50. A roll of optical film comprising an absorbing polarizer characterized by an absorbing polarizer block axis and a reflective polarizer characterized by a reflective polarizer block axis, the reflective polarizer comprising (i) at least one birefringent material characterized by an effective orientation axis and at least one isotropic material or (ii) a first birefringent material characterized by an effective orientation axis and a second birefringent material characterized by an effective orientation axis;
wherein the optical film has a width of greater than about 0.3 m, a thickness of at least 200 microns and a length of at least about 10 m, and the absorbing polarizer block axis, the effective orientation axes of the one or more birefringent materials and the reflective polarizer block axis are all aligned along the length of the optical film.

51. The roll of optical film as recited in claim 50, wherein the optical film has a width of at least 0.65 m.

52. The roll of optical film as recited in claim 50, wherein the optical film has a width of at least 1.3 m.

53. The roll of optical film as recited in claim 50, wherein the optical film has a width of at least 1.8 m.

54. The roll of optical film as recited in claim 50, wherein the optical film has a width of 0.5 m to about 10 m.

55. The roll of optical film as recited in claim 50, further comprising a retarder.

56. The roll of optical film as recited in claim 50, wherein the absorbing polarizer comprises iodine and polyvinyl alcohol.

57. The roll of optical film as recited in claim 50, further comprising an adhesive layer disposed between the absorbing polarizer and the reflective polarizer.

58. The roll of optical film as recited in claim 50, further comprising a protective layer.

59. The roll of optical film of claim 50, wherein the optical film has a thickness of at least 250 micrometers.

60. The roll of optical film of claim 50, wherein a normalized refractive index difference along the length of the optical film (MD) between the first polymeric material and the second polymeric material is more than about 0.06.

61. A method of processing an optical film, comprising calendering a polymeric material comprising a first polymer, a second polymer, and a third polymer, wherein at least one of the polymers develops birefringence.

62. The method of claim 61 wherein the first, second, and third polymers are disposed in a blend.

63. The method of claim 62 wherein the second and third polymers form a continuous phase and the first polymer forms a disperse minor phase within the continuous phase.

64. The method of claim 63 wherein the second and third polymers comprise PEN and PET.

65. The method of claim 63 wherein the first polymer comprises syndiotactic polystyrene or polycarbonate.
